(19) United States
(12) Patent Application Publication
(10) Pub. No.: US 2015/0200861 A1
(43) Pub. Date: Jul. 16, 2015

(54) APPARATUS AND METHOD FOR CONTROLLING A WEB LOADING TIME IN A NETWORK

(71) Applicant: Samsung Electronics Co., Ltd., Gyeonggi-do (KR)

(72) Inventors: Jake Lee, Seoul (KR); Young-Joong Mok, Gyeonggi-do (KR); Jung-Shin Park, Seoul (KR); Antony Franklin, Gyeonggi-do (KR)

(21) Appl. No.: 14/595,704

(22) Filed: Jan. 13, 2015

(30) Foreign Application Priority Data
Jan. 13, 2014 (KR) 10-2014-0004195

(51) Int. Cl. H04L 12/833; H04L 29/06; H04L 29/08

(52) U.S. Cl. CPC H04L 47/2458; H04L 67/10; H04L 67/42

(57) ABSTRACT

The present disclosure relates to a method and apparatus to control a web loading time in a network. A method of a network controller to control a web loading time of a terminal includes acquiring information regarding at least one terminal currently accessing a base station. The method also includes detecting a transmission control protocol (TCP) session to download a web content of the terminal. The method further includes among a main object and at least one embedded object included in the web content, adjusting a priority for a transmission of the main object. Accordingly, a loading time of a web content is decreased by increasing a transmission priority of a main object constituting the web content in a network congestion situation.

### PRIORITY

The present application is related to and claims the benefit under 35 U.S.C. §119(a) of a Korean patent application filed in the Korean Intellectual Property Office on Jan. 13, 2014 and assigned Serial No. 10-2014-0004195, the entire disclosure of which is hereby incorporated by reference.

### TECHNICAL FIELD

The present disclosure relates to a technique for controlling a web content loading time of a terminal in a network congestion situation.

### BACKGROUND

In general, a wireless mobile communication terminal such as a smart phone transmits or receives a web content by accessing the Internet via a base station. For example, when a web browser is executed by a user, the mobile communication terminal requests the base station to provide the web content, the base station accesses a corresponding server through the internet to receive the web content requested by the mobile communication terminal from the server, and provides the received web content to the mobile communication terminal.

Since a transmission or reception of the web content is delayed in general in a network congestion situation, it can take a long time for the mobile communication terminal to completely load the web content. However, in general, the user of the mobile communication terminal desires to receive the web content requested by the user within a short time period. Accordingly, in one of research projects for improving a user satisfaction in the mobile communication terminal, it is important to decrease a time consumed from when the web content is requested by the user to when the web content is loaded.

### SUMMARY

To address the above-discussed deficiencies, it is a primary object to provide a method and apparatus for controlling a web content loading time of a terminal in a network congestion situation.

Another exemplary embodiment of the present disclosure provides a method and apparatus for decreasing a loading time of a web content by adjusting a transmission priority of objects constituting the web content in a network congestion situation.

Another exemplary embodiment of the present disclosure provides a method and apparatus for decreasing a loading time of a web content by increasing a transmission priority of a main object constituting the web content in a network congestion situation.

Another exemplary embodiment of the present disclosure provides a method and apparatus for detecting a start and end of a main object in order to adjust a transmission priority of the main object constituting the web content in a network congestion situation.

Another exemplary embodiment of the present disclosure provides a method and apparatus for reporting a start and end of a main object for a web content in a server on the basis of management information included in the server.

Another exemplary embodiment of the present disclosure provides a method and apparatus for detecting and reporting a start and end of a main object for a web content on the basis of a keyword in a Deep Packet Inspection (DPI) device.

Another exemplary embodiment of the present disclosure provides a method and apparatus for detecting and reporting a start and end of a main object for a web content on the basis of a web packet generation time in a terminal.

Another exemplary embodiment of the present disclosure provides a method and apparatus for detecting and reporting a start and end of a main object for a web content on the basis of a web browser in a terminal.

In a first example, a method of a network controller for controlling a web loading time of a terminal is provided. The method includes acquiring information regarding at least one terminal currently accessing a base station. The method also includes detecting a transmission control protocol (TCP) session to download a web content of the terminal. The method further includes among a main object and at least one embedded object included in the web content, adjusting a priority for a transmission of the main object.

In a second example, a method of a network constitutional element for controlling a web loading time of a terminal is provided. The method includes among a main object and at least one embedded object included in a web content of the terminal, detecting a transmission start and end of the main object. The method also includes reporting the transmission start and end of the main object to a network controller.

In a third example, an apparatus of a network controller for controlling a web loading time of a terminal is provided. The apparatus includes a transceiver configured to acquire information regarding at least one terminal currently accessing a base station. The apparatus also includes a controller configured to perform a function of detecting a TCP session to download a web content of the terminal. The controller is also configured to among a main object and at least one embedded object included in the web content, adjust a priority for a transmission of the main object.

In a fourth example, an apparatus of a network constitutional element for controlling a web loading time of a terminal is provided. The apparatus includes a controller configured to among a main object and at least one embedded object included in a web content of the terminal, detect a transmission start and end of the main object. The apparatus also includes a transceiver configured to report the transmission start and end of the main object to a network controller.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example method of receiving a normal web content according to this disclosure;

FIG. 2A illustrates an example method of receiving a web content in a network non-congestion situation according to this disclosure;

FIG. 2B illustrates an example method of receiving a web content in a network congestion situation according to this disclosure;

FIG. 3 illustrates an example of adjusting a transmission priority of a main object constituting a web content in a network congestion situation according to this disclosure;

FIG. 4 illustrates an example method of receiving a web content in a network congestion situation according to this disclosure;

FIG. 5 illustrates an example structure of a system for controlling a web content loading time in a network congestion situation according to this disclosure;

FIG. 6A illustrates an example method for controlling a priority of a web content in a network controller according to this disclosure;

FIG. 6B illustrates an example method for controlling a priority of a web content in a network controller according to this disclosure;

FIG. 7 is a block diagram of an example network controller according to this disclosure;

FIG. 8 illustrates an example method of reporting a start and end of a main object in a constitutional element of a network according to this disclosure;

FIG. 9 illustrates an example method of reporting a start and end of a main object in a server according to this disclosure;

FIG. 10 illustrates an example method of reporting a start and end of a main object in a deep packet inspection (DPI) device according to this disclosure;

FIG. 11A illustrates an example method of a network controller for a case where a start and end of a main object are reported in a DPI device according to this disclosure;

FIG. 11B illustrates an example method for reporting a start and end of a main object in a DPI device according to this disclosure;

FIG. 12 illustrates an example method of reporting a start and end of a main object in a terminal according to this disclosure;

FIG. 13A illustrates an example method of a network controller for a case where a start and end of a main object are reported by using a web packet generation time in a terminal according to this disclosure;

FIG. 13B illustrates an example method for reporting a start and end of a main object by using a web packet generation time in a terminal according to this disclosure; and

FIG. 14 is an example block diagram illustrating a structure of a network constitutional element for reporting a start and end of a main object according to this disclosure.

### DETAILED DESCRIPTION

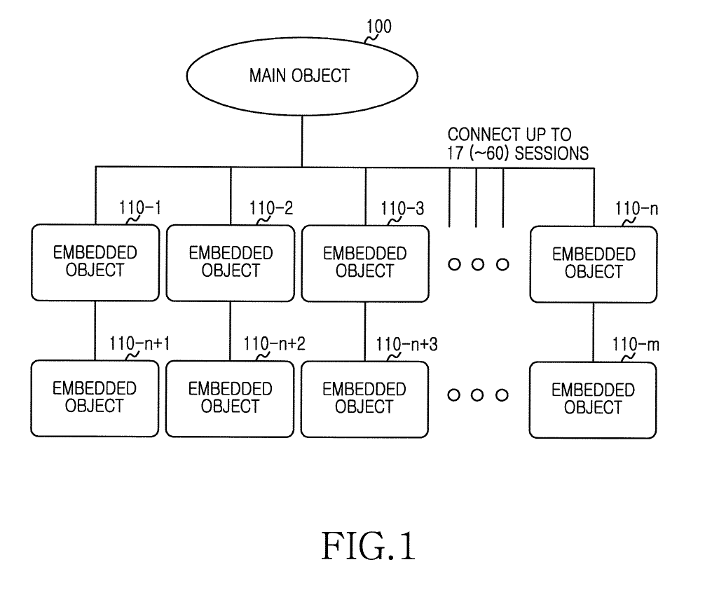

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure is implemented in any suitably arranged electronic device or communication system. Hereinafter, various exemplary embodiments of the present disclosure are described with reference to the accompanying drawings. While the various exemplary embodiments of the present disclosure are susceptible to various modifications and alternative forms, a specific embodiment thereof has been shown by way of example in the drawings and will herein be described in detail. It should be understood, however, that it is not intended to limit the various exemplary embodiments of the present disclosure to the particular form disclosed, but, on the contrary, the various exemplary embodiments of the present disclosure are to cover all modifications and/or equivalents and alternatives falling within the spirit and scope of the various exemplary embodiments of the present disclosure as defined by the appended claims. Like reference numerals denote like constitutional elements throughout the drawings.

The expression “include” or “include” used in the various exemplary embodiments of the present disclosure is intended to indicate a presence of a corresponding function, operation, or constitutional element disclosed herein, and it is not intended to limit a presence of one or more functions, operations, or components. In addition, in the various exemplary embodiments of the present disclosure, the term “include” or “have” is intended to indicate that characteristics, numbers, steps, operations, constitutional elements, and components disclosed in the specification or combinations thereof exist, and thus should be understood that there are additional possibilities of one or more other characteristics, numbers, steps, operations, constitutional elements, components or combinations thereof.

In various exemplary embodiments of the present disclosure, an expression “A or B”, “at least one of A and/or B” or the like may include some or all possible combinations of items enumerated together. For example, “A or B” or “at least one of A and/or B” may include a case where A is included, a case where B is included, or a case where both A and B are included.

Although expressions used in various exemplary embodiments of the present disclosure such as “1^{st}”, “2^{nd}”, “first”, “second” may be used to express various constitutional elements of the various exemplary embodiments, it is not intended to limit the corresponding constitutional elements. For example, the above expressions are not intended to limit an order and/or an importance of the corresponding constitutional elements. The above expressions may be used to distinguish one constitutional element from another constitutional element. For example, a 1^{st} user device and the 2^{nd} user device are both user devices, and indicate different user devices. For example, a 1^{st} constitutional element may be termed a 2^{nd} constitutional element, and similarly, the 2^{nd} constitutional element may be termed the 1^{st} constitutional element without departing from the scope of the various exemplary embodiments of the present disclosure.

When a constitutional element is mentioned as being “connected” to or “accessing” another constitutional element, this may mean that it is directly connected to or accessing the other constitutional element, but it is to be understood that there are no intervening constitutional elements present. On the other hand, when a constitutional element is mentioned as being “directly connected” to or “directly accessing” another constitutional element, it is to be understood that there are no intervening constitutional elements present.

An expression “configured to” used in the present document may be interchangeably used with, for example, “suitable for”, “having the capacity to”, “designed to”, “adapted to”, “made to”, or “capable of” according to a situation. A term “configured to” may not imply only “specially designed to” in a hardware manner. Instead, in a certain situation, an expressed “a device configured to” may imply that the device is “capable of” together with other devices or components. For example, “a processor configured to perform A, B, and C” may imply a dedicated processor (such as an embedded processor) for performing a corresponding operation or a generic-purpose processor (such as Central Processing Unit (CPU) or an application processor) capable of performing corresponding operations by executing one or more software programs stored in a memory device.

The terminology used in various exemplary embodiments of the present disclosure is for the purpose of describing particular exemplary embodiments only and is not intended to be limiting of the various exemplary embodiments of the present disclosure. A singular expression includes a plural expression unless there is a contextually distinctive difference therebetween.

Unless otherwise defined, all terms (including technical and scientific terms) used herein have the same meaning as commonly understood by those ordinarily skilled in the art to which various exemplary embodiments of the present disclosure belong. It will be further understood that terms, such as those defined in commonly used dictionaries, should be interpreted as having a meaning that is consistent with their meaning in the context of the relevant art and the various exemplary embodiments of the present disclosure, and will not be interpreted in an idealized or overly formal sense unless expressly so defined herein.

In addition, although a wireless communication network is described in the specification, an operation achieved in the wireless communication network is achieved in a process of controlling a network and transmitting data in a system (such as a base station) which manages the wireless communication system, or the operation is achieved in a terminal coupled to the wireless network.

A wireless communication system according to an exemplary embodiment of the present disclosure includes a plurality of Base Stations (BSs). Each BS provides a communication service to a specific geographical region (generally called a cell). The cell is divided into a plurality of regions (or sectors).

A Mobile Station (MS) can be fixed or mobile, and can also be called other terms such as a User Equipment (UE), a Mobile Terminal (MT), a User Terminal (UT), a Subscriber Station (SS), a wireless device, a Personal Digital Assistant (PDA), a wireless modem, a handheld device, or the like.

The BS is generally a fixed station which communicates with the MS, and also be called other terms such as an evolved-NodeB (eNB), a Base Transceiver System (BTS), an access point, and the like. The cell should be interpreted in a comprehensive meaning for indicating a part of an area covered by the BS, and includes all various coverage areas such as a mega cell, a macro cell, a micro cell, a pico cell, a femto cell, and the like.

The following description relates to a method and apparatus for decreasing a loading time of a web content by adjusting a transmission priority of objects constituting the web content in a network congestion situation. Herein, the web content consists of one main object and at least one embedded object, and includes data provided through the Internet. Hereinafter, a case where the web content is a web page is described for example for convenience of explanation. Herein, the main object implies an object to be first received to a terminal among objects included in the web content. For example, the web page consists of the main object, such as a Hypertext Markup Language (HTML) page, and the embedded object, such as an image, a script, a flash, Cascading Style Sheets (CSS), a video, an audio, and the like. Herein, the HTML as the main object includes information of embedded objects which need to be additionally downloaded to constitute the web page.

FIG. 1 illustrates an example method of receiving a normal web content according to this disclosure. Referring to FIG. 1, a terminal downloads a main object 100 (such as an HTML page) in an initial web page access. The terminal acquires information of embedded objects 110-1, 110-2, 110-3, to 110-n, which need to be additionally downloaded, from the downloaded main object 100, and requests a transmission of the embedded objects 110-n+1, 110-n+2, 110-n+3, to 110-m by using the acquired information. In this case, the terminal simultaneously downloads a plurality of embedded objects according to the number of transmission control protocol (TCP) sessions that is supported simultaneously. For example, the terminal simultaneously supports 17, 23, or 60 TCP sessions according to a manufacturer or an operating system. Accordingly, in the initial web page access, the main object is downloaded through one TCP session, and thereafter 17, 23, or 60 TCP sessions is generated to request the transmission of the embedded objects, and the embedded objects is simultaneously received from a web server through respective sessions.

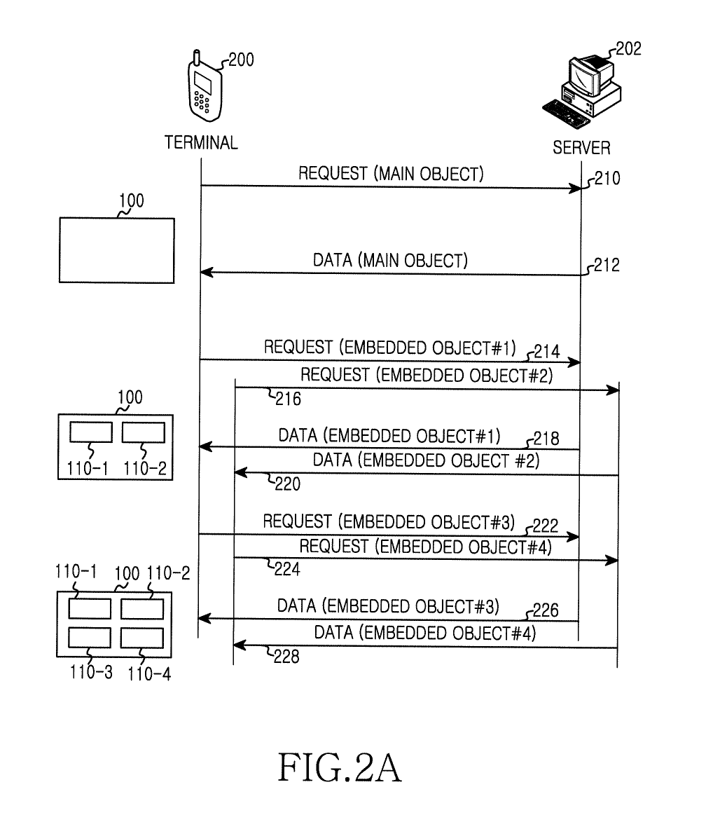

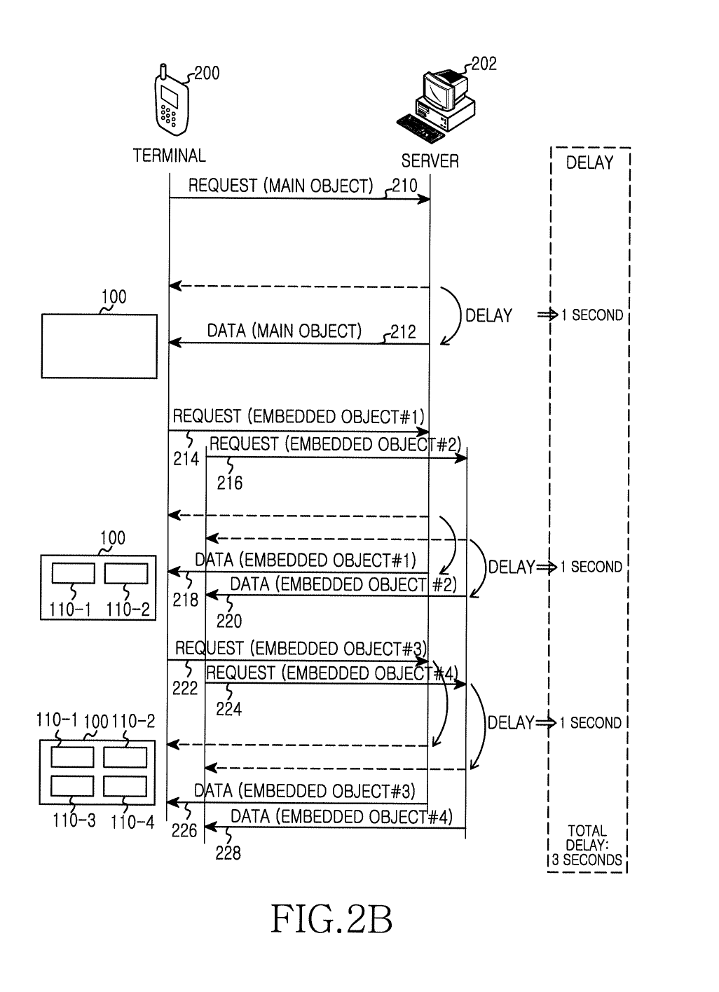

FIG. 2A illustrates an example method of receiving a web content in a network non-congestion situation according to this disclosure. For convenience of explanation, it is assumed herein that a terminal simultaneously supports two TCP sessions, and a web page includes four embedded objects. As shown in FIG. 2A, when a web page access is requested by a user, a terminal 200 requests a server 202 to transmit a main object corresponding to the web page in step 210. The server 202 receives from the terminal 200 the request for transmitting the main object corresponding to the web packet, and then in step 212, transmits the main object (such as an HTML page) to the terminal 200. In this case, the terminal 200 generates a graphic interface corresponding to a main object 100 and displays it to a screen.

The terminal 200 analyzes the main object and acquires information (such as identification information) regarding four embedded objects included in the web page, and thereafter requests a transmission of two embedded objects through two TCP sessions as shown in steps 214 and 216. Herein, a signal for requesting the transmission of the embedded objects includes identification information of each embedded object which requests the transmission. Herein, a request signal of step 214 and a request signal of step 216 is transmitted simultaneously through different two TCP sessions. Thereafter, the server 202 transmits the two embedded objects requested from the terminal 200 through the two TCP sessions as shown in steps 218 and 220. In this case, the terminal 200 generates a graphic interface corresponding to two embedded objects 110-1 and 110-2, and additionally displays it to a screen.

Upon reception of the two embedded objects among the four embedded objects included in the web page, the terminal 200 requests a transmission of the remaining two embedded objects through two TCP sessions as shown in steps 222 and 224. Herein, a signal for requesting the transmission of the embedded objects includes identification information of each of the remaining two embedded objects for requesting the transmission. Herein, a request signal of step 222 and a request signal of step 224 is transmitted simultaneously through different two TCP sessions. Thereafter, the server 202 transmits the remaining two embedded objects requested from the terminal 200 through the two TCP sessions as shown in steps 226 and 228. In this case, the terminal 200 generates a graphic interface corresponding to the remaining two embedded objects 110-3 and 110-4 and additionally displays it to the screen.

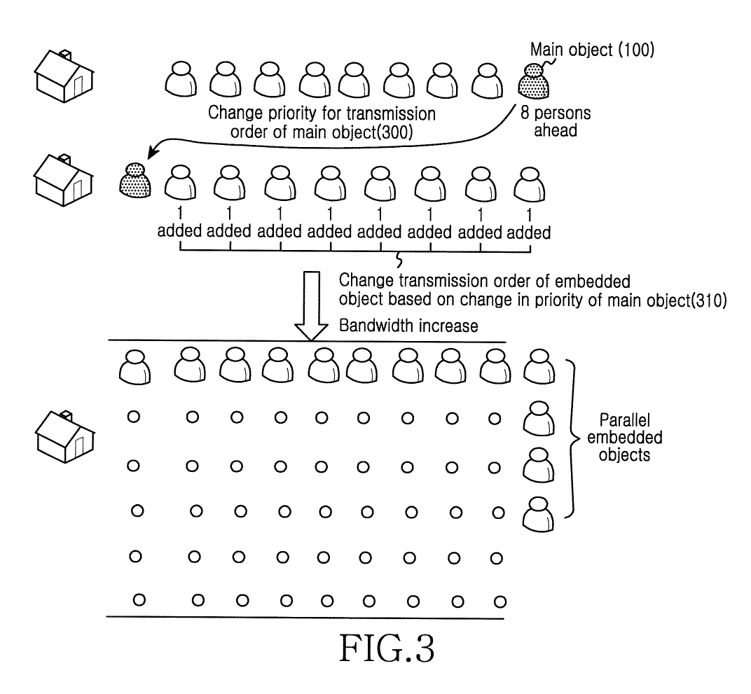

FIG. 2B illustrates an example method of receiving a web content in a network congestion situation according to this disclosure. Similarly to FIG. 2A, it is assumed in FIG. 2B that a terminal simultaneously supports two TCP sessions, and a web page includes four embedded objects. As shown in FIG. 2B, a signal flow for receiving a web content by a terminal 200 from a server 202 is the same as FIG. 2A. However, FIG. 2B assumes a network congestion situation, and shows a situation where all packets transmitted from the server 202 to the terminal 200 are transmitted with a delay due to a network congestion. For example, a transmission time of a main object transmitted from the server 202 to the terminal 200 is delayed by about 1 second in comparison with the transmission of the main object shown in FIG. 2A. In addition, a transmission time of each embedded object transmitted from the server 202 to the terminal 200 is delayed by about 1 second in comparison with the transmission time of the embedded objects shown in FIG. 2A. That is, when the terminal 200 downloads the web page in the network congestion situation, a time of completely downloading the web page is delayed by about 3 seconds in comparison with a case where the web page is downloaded in a network non-congestion situation. Accordingly, in the exemplary embodiment of the present disclosure, in order to decrease a web content download time in a network congestion situation, a transmission priority of a main object is adjusted to be high as shown in FIG. 3 described below.

FIG. 3 illustrates an example of adjusting a transmission priority of a main object constituting a web content in a network congestion situation according to this disclosure. Although a case where one object is transmitted by using only one packet is assumed herein for convenience of explanation, the present disclosure also equally applies to a case where one object is transmitted by using a plurality of packets.

Referring to FIG. 3, it is assumed a case where a data packet corresponding to a main object 100 is present among a plurality of data packets which are on standby to be transmitted in a network congestion situation. It is also assumed that a data packet corresponding to the main object 100 is the last to arrive among a plurality of data packets which are on standby to be transmitted in a corresponding network node. In a normal situation, a data packet corresponding to the main object 100 is transmitted later than the plurality of data packets which are on standby to be transmitted. However, in the network congestion situation, the data packet corresponding to the main object 100 is transmitted earlier than different data packets by changing a transmission priority to be high (see 300). In this case, the different data packets are embedded objects. Since a priority of the data packet corresponding to the main packet is changed to be high, a priority of the different data packets is relatively decreased by 1. Accordingly, the different packets are transmitted with a delay (see 310).

However, from a viewpoint of the terminal, if the aforementioned scheme of changing the transmission priority of the main object is supported, the terminal downloads the main object corresponding to the web page earlier in comparison with a case where the transmission priority of the main object is not changed. Accordingly, a time of acquiring information regarding the embedded object included in the web page by the terminal and a time of requesting the embedded object also becomes earlier. Therefore, if the transmission priority of the main object corresponding to the web page in the network congestion situation is changed as in the exemplary embodiment of the present disclosure, a download of the web page is complete earlier than a case where the transmission priority of the main object is not changed.

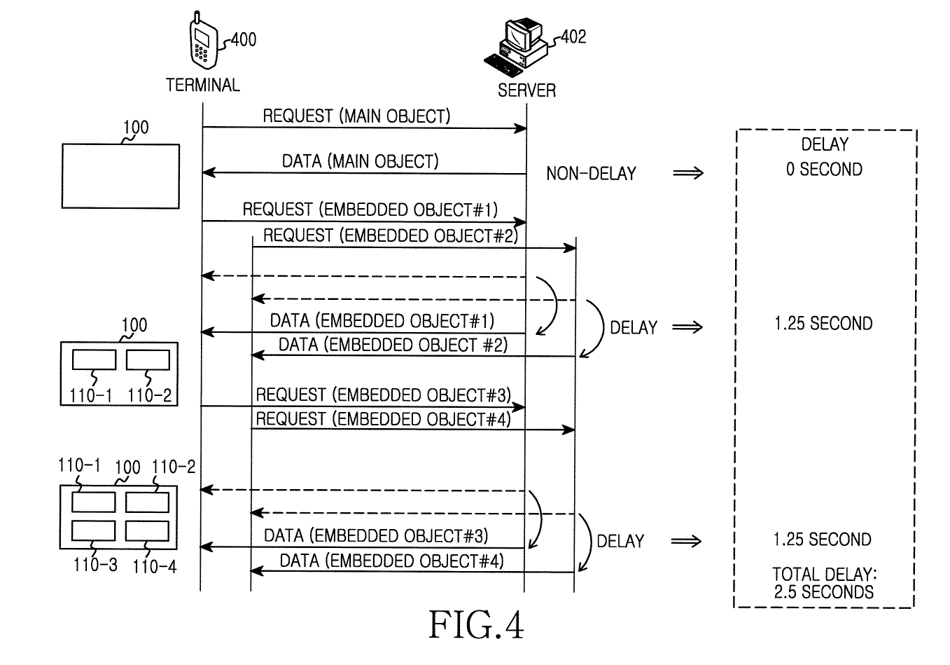

FIG. 4 illustrates an example method of receiving a web content in a network congestion situation according to this disclosure. Similarly to FIG. 2A, it is assumed in FIG. 4 that a terminal simultaneously supports two TCP sessions, and a web page includes four embedded objects. As shown in FIG. 4, a signal flow for receiving the web content by a terminal 400 from a server 402 is the same as FIG. 2A and FIG. 2B. However, according to the exemplary embodiment of the present disclosure, FIG. 4 is different in that a transmission priority of data corresponding to a main object is adjusted when packets transmitted from the server 402 to the terminal 400 experiences a transmission delay in a network congestion situation. For example, by changing a priority for determining a transmission order of the main object transmitted from the server 402 to the terminal 400, the main object is transmitted to the terminal 400 without a delay. In this case, since a priority of different packets other than the main object is relatively decreased, a delay time of 1 second which is to be experienced by the main object in the network congestion situation is distributed and applied to embedded packets. Accordingly, a transmission time of each embedded object transmitted from the server 402 to the terminal 400 is delayed by about 1.25 seconds in comparison with the transmission time of the embedded objects shown in FIG. 2A. Herein, since four embedded objects are transmitted by being divided into two steps in total, in a case where the transmission priority of the main object is adjusted when the terminal 400 downloads a web page in a network congestion situation, a time of completing the download of the web page is delayed by about 2.5 seconds in total in comparison with a case where the web page is downloaded in a network non-congestion situation. Accordingly, in the case where the transmission priority of the main object is changed in the network congestion situation as proposed in the exemplary embodiment of the present disclosure, the download delay time of the web page is decreased by about 0.5 second in comparison with the case where the transmission priority is not changed.

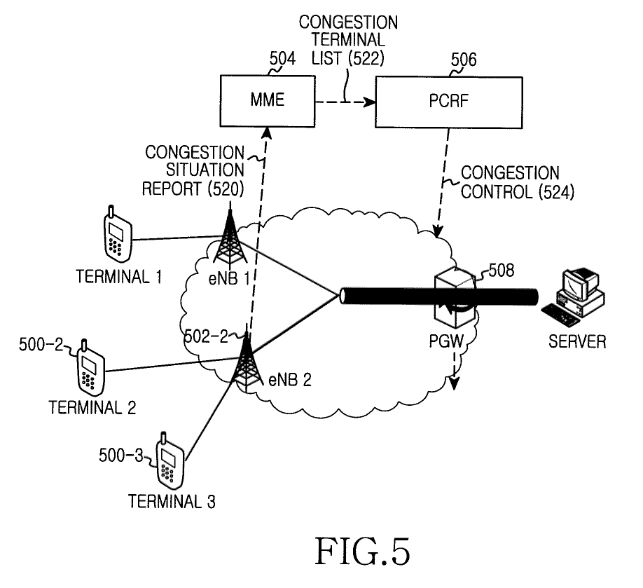

FIG. 5 illustrates an example structure of a system for controlling a web content loading time in a network congestion situation according to this disclosure. Referring to FIG. 5, an eNB2 502-2 detects that a network congestion situation occurs due to an access of a plurality of terminals, and reports to a Mobility Management Entity (MME) 504 that a resource is insufficient due to the network congestion situation in step 520. The MME 504 confirms information of terminals 500-2 and 500-3 currently accessing the eNB2 502-2 which reports the congestion situation, and transmits a congestion terminal list 522 including information of the terminals currently accessing the congestion eNB2 502-2 to a Policy and Charging Rule Function (PCRF) 506 or a network controller. Herein, the congestion terminal list includes an Internet Protocol (IP) of a congestion control target terminal currently accessing the congestion eNB.

The PCRF 506 confirms at least one congestion control target terminal on the basis of the congestion control terminal list received from the MME 504, and performs the congestion control function for a web traffic of the terminal in step 524. For example, the PCRF 506 determines whether the web traffic is generated on the basis of a destination port address of a TCP session corresponding to the terminal, and if the TCP session corresponding to the terminal corresponds to the web traffic, adjusts a transmission priority of the TCP session by controlling a PGW 508. Herein, the destination port address of the TCP session corresponding to the web traffic is 80 or 8080.

In the exemplary embodiment of the present disclosure, the congestion control function for the web traffic, that is, the transmission priority of the TCP session for the web traffic, is adjusted by using two methods. In a first method, a priority of a bearer of a terminal corresponding to a web traffic is adjusted. For example, in this method, the priority of the bearer is increased upon detection of a start of a main object corresponding to the web page, and the priority of the bearer is restored to its original value upon detection of an end of the main object.

In a second method, a priority is directly indicated to a packet of the main object corresponding to the web page. For example, in this method, upon detection of a start of the main object corresponding to the web page, a priority of a corresponding TCP session is changed to be high and the changed priority is written to a Differentiated Service Code Point (DSCP) field in an IP header of the packet corresponding to the main object in the TCP session, and upon detection of an end of the main object, a priority before the change is written to the DSCP field in the IP header of the packet in the TCP session. In this case, network constitutional elements which are present on a transmission path of a packet determines a transmission order of the packet on the basis of a priority written to the packet.

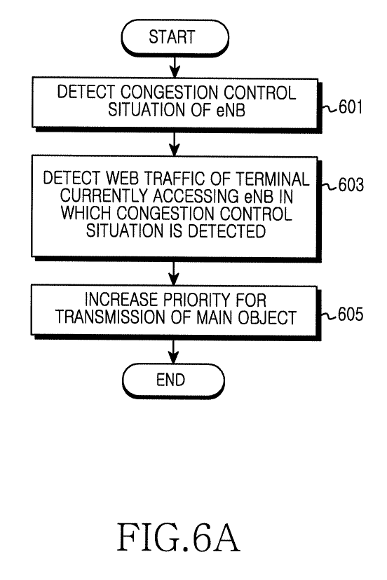

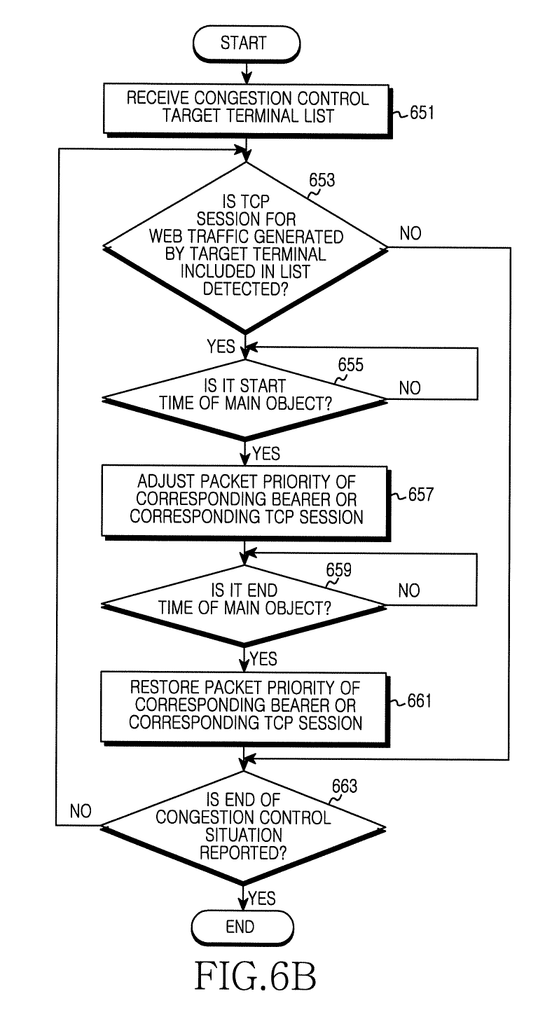

FIG. 6A illustrates an example method for controlling a priority of a web content in a network controller according to this disclosure. Herein, the network controller is the PCRF 506. Referring to FIG. 6A, the network controller 506 detects a congestion control situation of an eNB in step 601. For example, the network controller 506 detects that it is a situation where a congestion control of the eNB is necessary by receiving from the MME 504 a report indicating that the congestion situation occurs in a specific eNB together with information of terminals currently accessing the specific eNB.

In step 603, the network controller 506 detects a web traffic of a terminal currently accessing an eNB in which a congestion control situation is detected. For example, when the congestion situation occurs in the eNB2 502-2, the network controller 506 confirms information of the congestion control target terminals 500-2 and 500-3 currently accessing the eNB2 502-5 in which the congestion situation is detected from information received from the MME 504, and detects a web traffic for the terminals 500-2 and 500-3. In this case, the network controller 506 detects a corresponding TCP session by using an IP address of a corresponding terminal, and detects a web traffic on the basis of a destination port address of the TCP session. For example, the network controller 506 detects that the web traffic is generated when a destination port address for the TCP session of the corresponding terminal is 80 or 8080. The network controller increases a priority for a transmission of a main object corresponding to the web traffic in step 605. For example, the network controller increases a priority for a transmission order of the main object transmitted through a TCP session corresponding to the terminal, so that the main object is transmitted to the terminal without a delay in a network congestion situation.

FIG. 6B illustrates an example method for controlling a priority of a web content in a network controller according to this disclosure. Herein, the network controller is the PCRF 506. Referring to FIG. 6B, the network controller 506 receives a list indicating a congestion control target terminal from a different network constitutional element in step 651. For example, the network controller 506 receives from the MME 504 a list including IP information of terminals currently accessing an eNB in which a congestion situation occurs.

The network controller 506 examines whether a TCP session is detected for a web traffic generated by the congestion control target terminal included in the received list in step 653. For example, the network controller 506 detects a TCP session corresponding to an IP address of at least one congestion control target terminal included in the received list, and examines whether it is the TCP session for the web traffic on the basis of a destination port address of the TCP session. For example, if a destination port address for a TCP session of a corresponding terminal is 80 or 8080, the network controller 506 detects that the TCP session is the TCP session corresponding to the web traffic. If the TCP session for the web traffic generated by the congestion control target terminal is not detected, the network controller 506 directly proceeds to step 663.

Otherwise, if the TCP session for the web traffic generated by the congestion control target terminal is detected, the network controller 506 detects whether it is a start time of a main object corresponding to the web traffic in step 655. For example, the network controller 506 receives a signal for reporting the start time of the main objet from a different network constitutional element (such as a server, a corresponding terminal, a DPI device, or the like), and thus detects that it is the start time of the main object corresponding to the web traffic. Further, the network controller 506 detects that it is the start time of the main object corresponding to the web traffic on the basis of whether a main object start flag is included in a packet transmitted through a TCP session.

If it is the start time of the main object, proceeding to step 657, the network controller 506 adjusts a packet transmission priority of a corresponding bearer or a corresponding TCP session. For example, if it is the start time of the main object, the network controller 506 sets a priority of a corresponding bearer to be high so that a transmission of the main object is not delayed in a network congestion situation, or writes a relatively higher priority than other packets to a DSCP field in an IP header of a packet corresponding to the main object.

In step 659, the network controller 506 detects whether it is an end time of the main object corresponding to the web traffic. For example, the network controller 506 receives a signal for reporting the end time of the main object from a different network constitutional element (such as a server, a corresponding terminal, a DPI device, or the like), and thus detects that it is the end time of the main object corresponding to the web traffic. Further, the network controller 506 detects that it is the end time of the main object corresponding to the web traffic on the basis of whether a main object end flag is included in a packet transmitted through a TCP session.

If it is the end time of the main object, proceeding to step 661, the network controller 506 restores a packet transmission priority of a corresponding bearer or a corresponding TCP session to its original value. For example, if it is the end time of the main object, the network controller 506 restores the priority of the bearer to a value before the priority adjustment of step 657, or writes a priority before the priority adjustment of step 657 to a DSCP field in an IP header of the packet corresponding to the main object. Thereafter, the network controller 506 examines whether an end of a congestion control situation is reported in step 663. For example, the network controller 506 receives a signal indicating an end of a congestion situation of a specific eNB from the MME 504. If the end of the congestion control situation is not reported, returning to step 653, the network controller 506 repeats the subsequent steps. Otherwise, if the end of the congestion control situation is reported, the procedure according to the exemplary embodiment of the present disclosure ends.

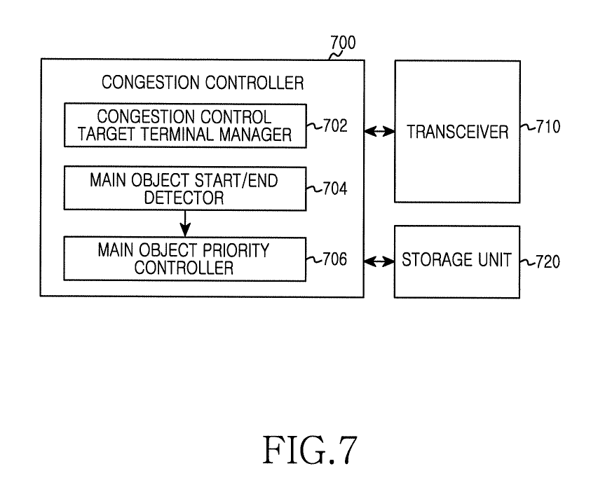

FIG. 7 is a block diagram of an example network controller according to this disclosure. Referring to FIG. 7, the network controller 506 includes a congestion controller 700, a transceiver 710, and a storage unit 720. The congestion controller 700 detects a network congestion situation and adjusts a priority for a transmission of a main object of a web content in the network congestion situation so as to perform a function for minimizing a delay of the web content.

In particular, the congestion controller 700 includes a congestion control target terminal manager 702, a main object start/end detector 704, and a main object priority controller 706. The congestion control target terminal manager 702 detects a TCP session for a web traffic generated by a congestion control target terminal, on the basis of a congestion control target terminal list received from a different network configuration element (such as an MME). Further, upon detection of the TCP session for the web traffic generated by the congestion control target terminal manager 702, the main object start/end detector 704 detects a start time and end time of a main object corresponding to the web content. For example, the main object start/end detector 704 detects the start time or end time of the main object corresponding to the web traffic on the basis of a signal for reporting the start time or end time of the main object from a different network constitutional element (such as a server, a corresponding terminal, a DPI device, or the like). Further, the main object start or end detector 704 detects the start time or end time of the main object corresponding to the web traffic on the basis of whether a main object start flag or a main object end flag is included in a packet transmitted through a TCP session. Further, upon detection of the main object start time by the use of the main object start/end detector 704, the main object priority controller 706 sets a packet transmission priority of a corresponding bearer or a corresponding TCP session to be high until the main object end time arrives and thus controls to avoid a transmission delay of the main object in a network congestion situation. Upon detection of the main object end time by the use of the main object start/end detector 704, the main object priority controller 706 restores the packet transmission priority of the bearer or the TCP session to its original value.

The transceiver 710 performs a signal transmission/reception function between the network controller 506 and a different network constitutional element. For example, the transceiver 710 receives a congestion control target terminal list from an MME, and receives a signal for reporting a start and/or end of a main object from a specific network constitutional element. The storage unit 720 stores a variety of data and programs required for an overall operation of the network controller 506. Further, the transceiver 710 stores and updates the congestion control target list received from a different network constitutional element (such as an MME). As described above, in the exemplary embodiment of the present disclosure, the network controller, such as the PCRF, detects the start and end of the main object to adjust a transmission priority for a corresponding TCP session. Therefore, the main object is transmitted to a terminal without a delay. Accordingly, a method of detecting the start and end of the main object will be described hereinafter.

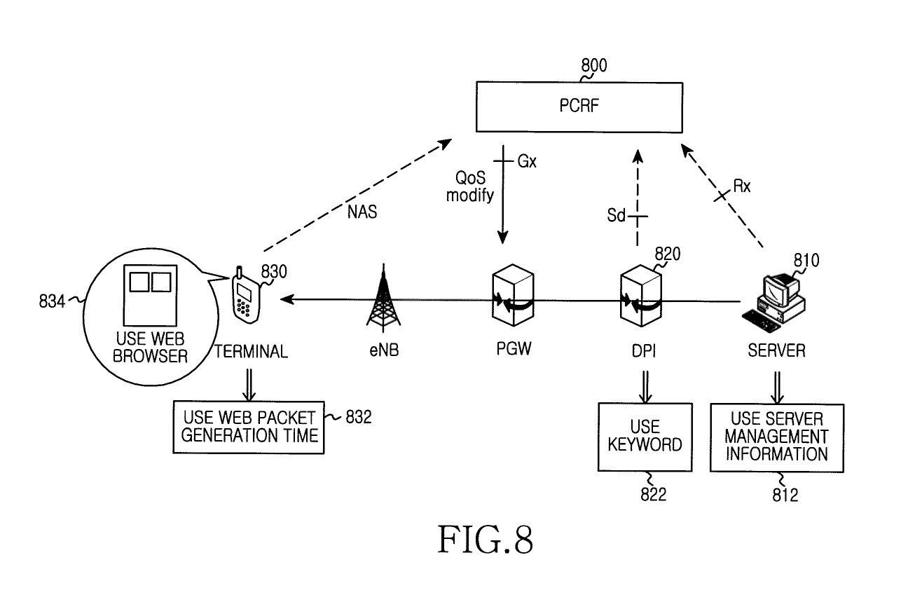

FIG. 8 illustrates a method of reporting a start and end of a main object in a constitutional element of a network according to various exemplary embodiments of the present disclosure.

FIG. 8 illustrates an example method of reporting a start and end of a main object in a constitutional element of a network according to this disclosure. Referring to FIG. 8, according to the exemplary embodiment of the present disclosure, various network constitutional elements transmits a start or end of the main object to a PCRF 800 which is a network controller. As shown in FIG. 8, the PCRF 800 receives a report indicating the start and end of the main object from a server 810, a DPI device 820, or a terminal 830, and detects the start and end of the main object according to an operation of the server 810. The PCRF 800 controls QoS by requesting a PGW to increase a priority for a transmission of the main object through a Gx interface upon detection of the start of the main object, and by requesting the PGW to restore (or decrease) the priority of the transmission of the main object through the Gx interface upon detection of the end time of the main object.

A first exemplary embodiment is a method in which the server 810 reports the start and end of the main object by using management information in the server (see 812). For example, the server 810 manages whether each of internal objects constituting a web content corresponds to a main object or an embedded object. In case of the main object, since it is recorded that the object is the main object by using metadata, whether it is the main object or the embedded object is determined by referring to the metadata of the object when responding to an HTTP request of the user. If it is determined that the object is the main object, the server 810 reports a delivery start and end of the main object. In this case, the server 810 reports the start and end of the main object by transmitting a signal directly through an Rx interface, or by controlling a packet transmitted to the PGW. For example, the server 810 transmits to the PCRF 800 a flag for reporting the start of the main object together with information of a corresponding TCP session (such as a source IP, a destination IP, a source port, a destination port) when a transmission of a packet corresponding to the main object starts, and transmits to the PCRF 800 a flag for reporting the end of the main object together with the information of the TCP session when the transmission of the packet corresponding to the main object ends. Further, the server 810 performs the transmission by directly indicating the flag for reporting the delivery start of the main object and the flag for reporting the delivery end of the main object to the packet corresponding to the main object. In this case, the PCRF 800 interworks with the PGW through a Gx interface to confirm the packet in which the flag for reporting the start of the main objet and/or the flag for reporting the end of the main object are indicated, and extracts the information of the TCP session (such as the source IP, the destination IP, the source port, the destination port) from the packet.

In a second exemplary embodiment, the DPI device 820 detects the start and end of the main object by using a pre-set keyword (see 822), and reports the start and end of the main object through an Sd interface. For example, the DPI device 820 monitors a packet provided to the PGW from the server 810, and reports the start of the main object to the PCRF 800 upon detection of a packet including a keyword indicating the start of the main object, and reports the end of the main object to the PCRF 800 upon detection of a packet including a keyword indicating the end of the main object. For example, since an HTML page which is generally a main object is a text file and includes a keyword “src=” indicating that information of an embedded object is included and “type=text/css” indicating that a css which serves for a web page design is embedded, such keywords are used as a keyword for detecting the start of the main object in the exemplary embodiment of the present disclosure.

In a third exemplary embodiment, the terminal 830 detects the start and end of the main object by using a web packet generation time (see 832), and reports the start and end of the main object by using a Non Access Stratum (NAS) equivalent to a control signal or transmits a packet corresponding to the main object by indicating a main object start flag and a main object end flag into the packet. For example, if the terminal 830 generates a web packet for a new TCP session while a web packet is not generated for a pre-set time period, it is detected that this is to start a download of the main object. In this case, the web packet implies that a TCP destination port number is 80 or 8080. Further, the terminal 830 determines whether it is a web packet for a new TCP session or a web packet for an old TCP session on the basis of information of a TCP session of the web packet (such as a source IP, a destination IP, a source port, a destination port). In general, when a user sees a web page through a web browser, a specific time is consumed from when loading of the web page is complete to when the user clicks the web page or inputs a URL to see another web page, and in this case, a characteristic in which a terminal does not transmit a packet to a network during the specific time duration is used. Further, a characteristic can also be used in which a new TCP session is generated to download a plurality of embedded objects when the download of the main object is complete. Therefore, the terminal 830 detects the start of the delivery of the main object when the web packet of the new TCP session is first generated while the web packet is not transmitted/received during the pre-set time, and detects the end of the delivery of the main object when the new TCP session is generated again after detection of the delivery start of the main object.

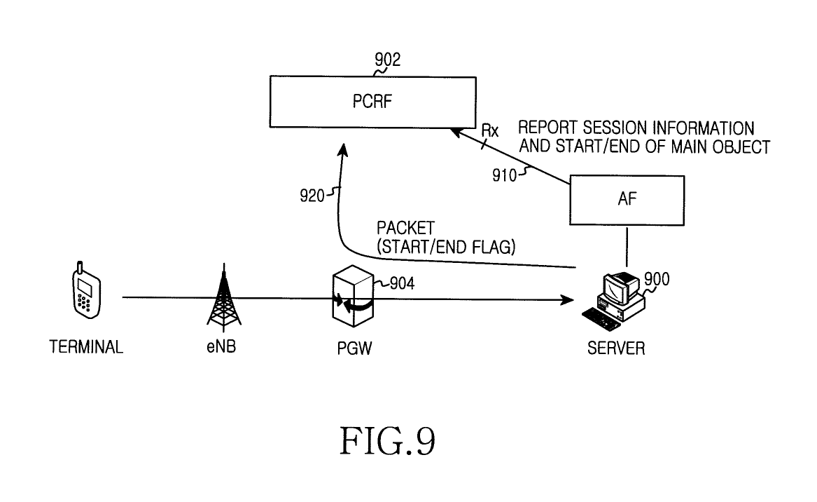

In a fourth exemplary embodiment, the terminal 830 detects the start and end of the main object by using the web browser (see 834), and reports the start and end of the main object by using a NAS equivalent to a control signal or transmits a packet corresponding to the main object by indicating a main object start flag and a main object end flag into the packet. For example, the web browser included in the terminal 830 downloads an HTML by using an internal software block called a main source loader when accessing a web by a user's selection operation or URL input. Thereafter, the web browser acquires information of an embedded object by interpreting the HTML, and downloads the embedded object by using an internal software block called a sub-resource loader. In doing so, the web browser determines whether an object to be downloaded is a main object or an embedded object. Accordingly, in the exemplary embodiment of the present disclosure, a modem of the terminal 830 receives a report indicating a download start time of the main object and a download start time of the embedded object from the web browser, and reports the start and end of the main object to the PCRF 800 on the basis thereof. Hereinafter, four exemplary embodiments for reporting the start and end of the main object will be described in detail with reference to FIG. 9 to FIG. 13B.

FIG. 9 illustrates an example method of reporting a start and end of a main object in a server according to this disclosure. Referring to FIG. 9, when a web content is stored, a server 900 stores and manages information indicating whether each of a plurality of objects constituting the web content is a main object or an embedded object. For example, information indicating that a corresponding object is a main object is stored in metadata of the main object constituting the web content. Accordingly, the server 900 detects a start and end of the main object by using internal storage information, and directly transmits a signal for reporting the start and end of the main object together with session information of the main object through an Rx interface (see 910) or reports the start and end of the main object by indicating a flag for reporting the start and end of the main object into a packet transmitted to a PGW (see 920).

For example, when data corresponding to the web content is requested from a user, the server 900 refers to metadata of an object corresponding to the data to determine whether the object is a main object or an embedded object, and if it is determined as the main object, reports to the PCRF 902 a delivery start of the main object together with information on a TCP session (such as a source IP, a destination IP, a source port, a destination port) in which a content is transmitted through an Rx interface. In this case, the server 900 reports to the PCRF 902 the information on the TCP session, so as to allow the PCRF 902 to identify the TCP session in which the delivery of the main object starts and to adjust a priority of the identified TCP session. Further, when the transmission of the main object is complete or when data corresponding to the embedded object of the content is requested from the user, the server 900 reports to the PCRF 902 the delivery end of the main object together with the information on the TCP session in which the main object of the web content is transmitted.

For another example, when data corresponding to the web content is requested from the user, the server 900 refers to metadata of an object corresponding to the data to determine whether the object is a main object or an embedded object, and if it is determined as the main object, records a flag indicating the start of the main object into a first packet corresponding to the object and record a flag indicating the end of the main object into a last packet corresponding to the object, so as to transmit the packets to the PGW 904. In this case, the PCRF 902 interworks with the PGW 904 through a Gx interface, and thus confirms a packet in which the flag for reporting the start of the main object is indicated among packets arrived to the PGW 904, and extracts information on a TCP session (such as a source IP, a destination IP, a source port, a destination port) from the packet, thereby increasing a transmission priority of the TCP session. Further, the PCRF 902 confirms a packet in which a flag for reporting the end of the main object is indicated among the packets arrived to the PGW 904, and extracts information of a TCP session from the packet. Thus, a transmission priority of the TCP session is restored (or decreased) to a value before the increase.

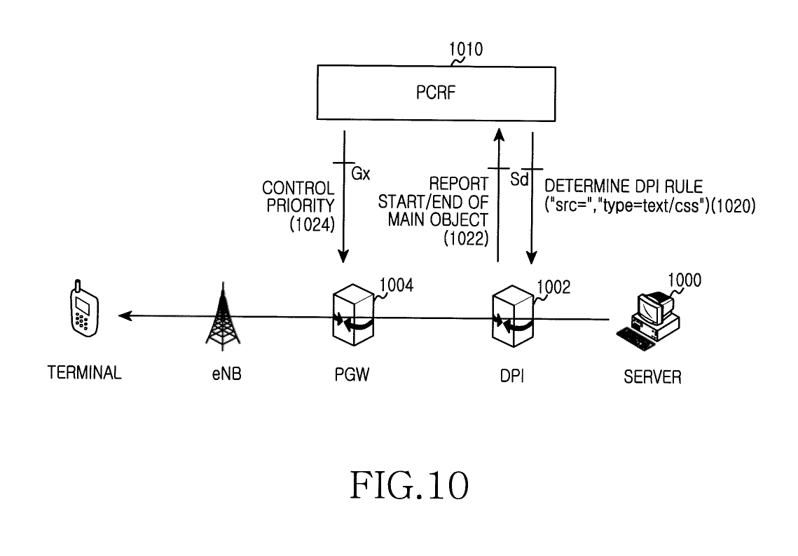

FIG. 10 illustrates an example method of reporting a start and end of a main object in a deep packet inspection (DPI) device according to this disclosure. Referring to FIG. 10, a DPI device 1002 receives a DPI rule for detecting the start and end of the main object from a PCRF 1010, and determines the received DPI rule (see 1020). For example, the DPI rule is determined such that the start of the main object is detected when “src=” or ‘type=text/css” is included in a packet and the end of the main object is detected when “HTTP OK” and “port 80” are included in the packet. Further, the DPI packet 1002 receives information of a congestion control target terminal.

Between a server 1000 and a PGW 1004, the DPI device 1002 monitors packets provided to the congestion control target terminal, and reports the delivery start of the main object to the PCRF 1010 through an Sd interface upon detection of a packet including a keyword indicating the start of the main object (see 1022), and reports the delivery end of the main object to the PCRF 1010 through the Sd interface upon detection of a packet including a keyword indicating the end of the main object (see 1022). The PCRF 1010 receives a report indicating the delivery start of the main object in a specific TCP session from the DPI device 1002, and interworks with the PGW 1004 through a Gx interface, thereby increasing a transmission priority for a packet of the TCP session in the PGW 1004. Further, the PCRF 1010 receives a report indicating the delivery end of the main object in the TCP session from the DPI device 1002, and interworks with the PGW 1004 through the Gx interface, thereby restoring or decreasing the transmission priority for the packet of the TCP session in the PGW 1004.

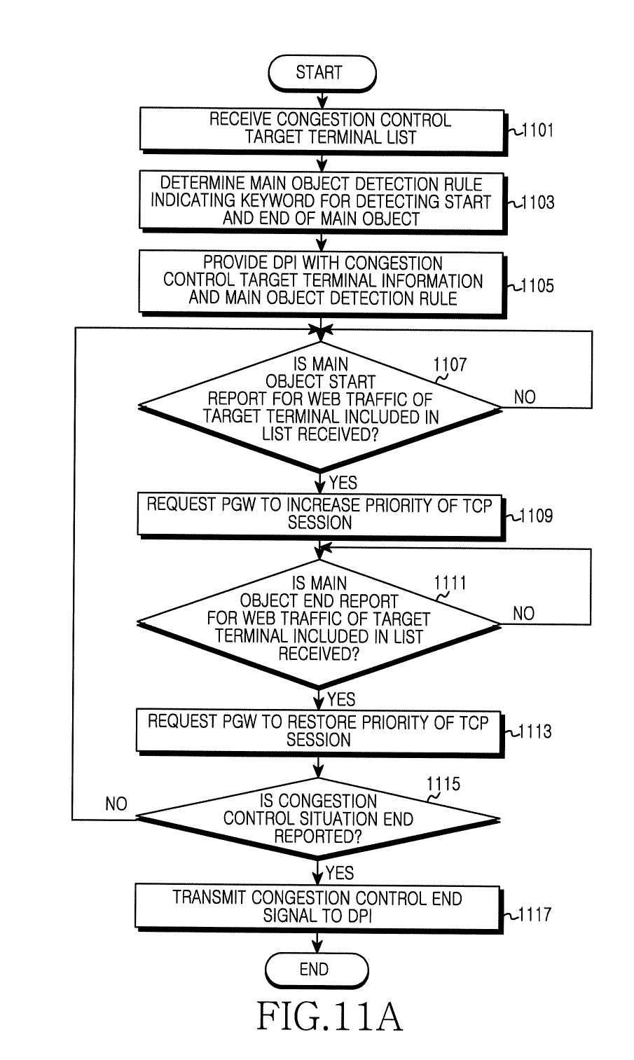

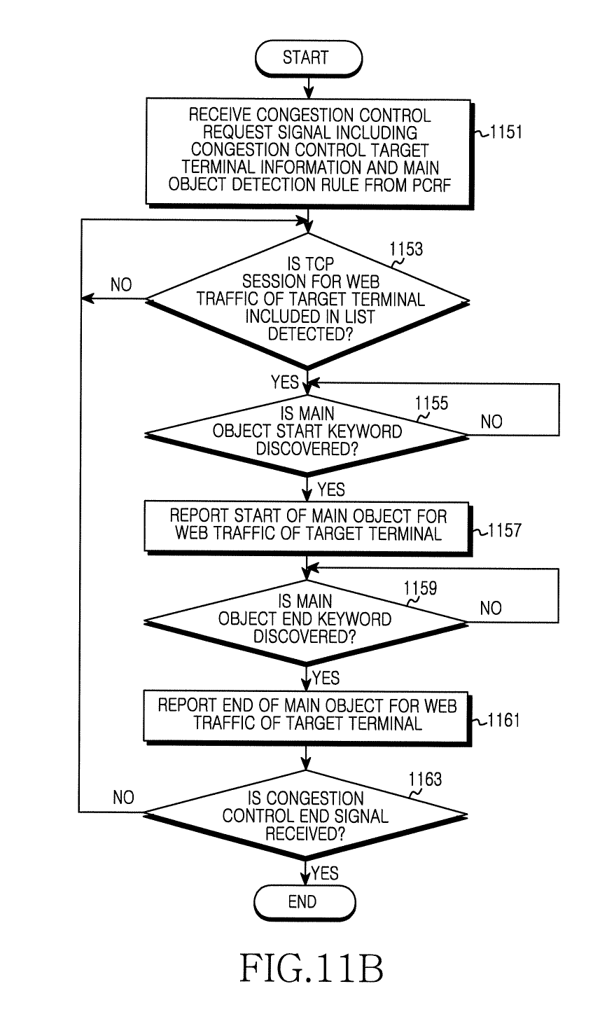

FIG. 11A illustrates an example method of a network controller for a case where a start and end of a main object are reported in a DPI device according to this disclosure. Herein, the network controller is the PCRF 1010. Referring to FIG. 11A, the network controller receives a congestion control target terminal list from a different network constitutional element (such as an MME) in step 1101. For example, the network controller receives a list of terminals currently accessing an eNB in which a congestion situation occurs.

In step 1103, the network controller determines a main object detection rule indicating a keyword for detecting a start and end of a main object. For example, the main object detection rule detects the start of the main object when “src=” or “type=text/css” is included in a packet, and detects the end of the main object when “HTTP OK” or “port 80” is included in the packet. In step 1105, the network controller provides information of the congestion control target terminal and the main object detection rule to the DPI device. In step 1107, the network controller examines whether a signal for reporting the start of the main object for the web traffic of the terminal included in the congestion control target terminal list is received from the DPI device. Upon reception of the signal for reporting the start of the main object for the web traffic of the terminal included in the congestion control target terminal list, in step 1109, the network controller requests the PGW to increase a priority of a corresponding TCP session. The network controller confirms information of the TCP session from the main object start reporting signal received from the DPI device, and requests to increase the priority on the basis of information of the confirmed TCP session.

In step 1111, the network controller examines whether a signal for reporting the end of the main object for the web traffic of the terminal included in the congestion control target terminal list is received from the DPI device. Upon reception of the signal for reporting the end of the main object for the web traffic of the terminal included in the congestion control target terminal list, in step 1113, the network controller requests the PGW to restore a priority of a corresponding TCP session. The network controller confirms information of the TCP session from the main object end reporting signal received from the DPI device, and requests to restore the priority on the basis of information of the confirmed TCP session.

In step 1115, the network controller examines whether a signal for reporting an end of a congestion control situation is received from a different network constitutional element (such as an MME). For example, the network controller examines whether a signal for reporting an end of a congestion situation of a specific eNB is received from the MME. If the end of the congestion control situation is not reported, returning to step 1107, the network controller repeats the subsequent steps. For example, the network controller examines whether a signal for reporting a start of a main object for a web traffic of a different terminal included in the congestion control target terminal list is received. Of course, the process for controlling the web traffic of each terminal included in the congestion control target terminal list is performed irrespective of a process for controlling the web traffic of the different terminal. Upon reception of the signal for reporting the end of the congestion control situation, in step 1117, the network controller transmits the congestion control end signal to the DPI device, and the procedure according to the exemplary embodiment of the present disclosure ends.

FIG. 11B illustrates an example method for reporting a start and end of a main object in a DPI device according to this disclosure. Referring to FIG. 11B, in step 1151, the DPI device receives a congestion control request signal including a congestion control target terminal list and a main object detection rule from a PCRF. For example, the main object detection rule detects the start of the main object when “src=” or “type=text/css” is included in a packet, and detects the end of the main object when “HTTP OK” or “port 80” is included in the packet. Further, the congestion control target terminal list includes IP information of a target terminal in which a start and end of a main object is detected.

In step 1153, the DPI device examines whether a TCP session for a web traffic of a target terminal included in the congestion control target terminal list is detected. Upon detection of the TCP session for the web traffic of the target terminal included in the congestion control target terminal list, in step 1155, a packet of the TCP session is monitored to examine whether a main object start keyword is discovered. For example, it is examined whether a packet including “src=” or “type=text/css” is discovered from packets of the TCP session. If the main object start keyword is discovered, in step 1157, the DPI device reports to a PCRF the start of the main object for the web traffic of the target terminal. In step 1159, the DPI device monitors a packet of the TCP session to examine whether a main object end keyword is discovered. For example, it is examined whether a packet including “HTTP OK” or “port 80” is discovered from packets of the TCP session. If the main object end keyword is discovered, in step 1161, the DPI device reports to the PCRF the end of the main object for the web traffic of the target terminal. In step 1163, the DPI device examines whether a congestion control end signal is received from the PCRF. If the congestion control end signal is not received, returning to step 1153, the DPI device repeats the subsequent steps. Otherwise, if the congestion control end signal is not received, the DPI device ends the procedure according to the exemplary embodiment of the present disclosure.

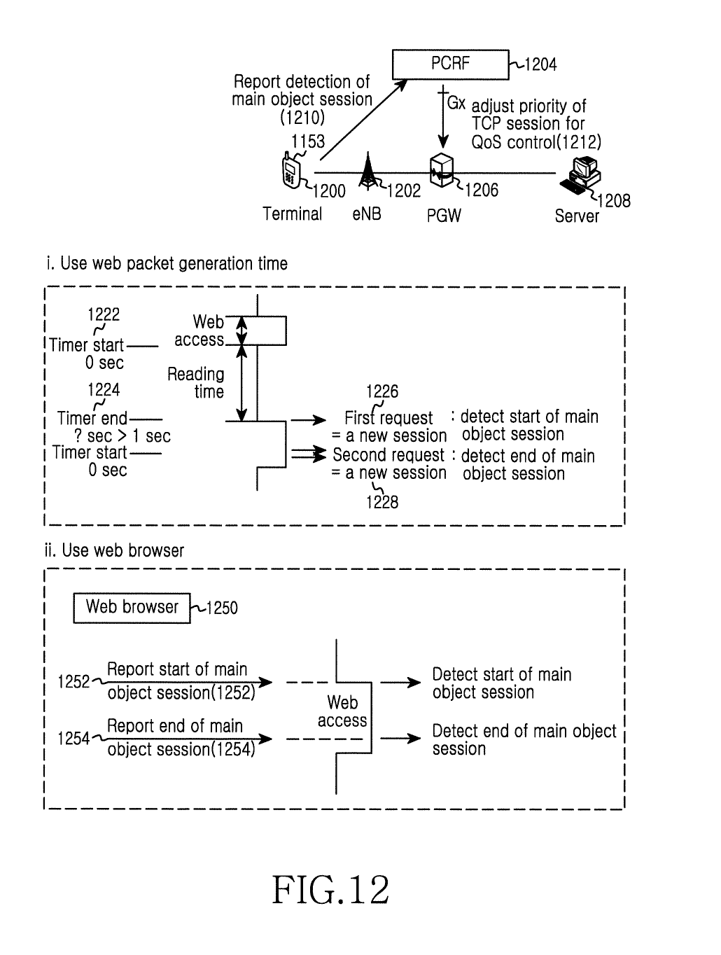

FIG. 12 illustrates an example method of reporting a start and end of a main object in a terminal according to this disclosure. Referring to FIG. 12, a terminal 1200 detects a start and end of a main object session, uses a NAS signal equivalent to a control signal to report to a PCRF 1204 that the start and end of the main object session is detected (see 1210), indicates a main object start flag to a packet which requests the main object, and transmits a packet which requests an embedded object by indicating a main object end flag into the packet. For example, in an LTE system, the terminal 1200 reports the start of the main object session by adding a flag indicating a main object delivery start to a bearer_modify_request signal, and reports the end of the main object session by adding a flag indicating a main object delivery end to the bearer_modify_request signal. In this case, the NAS signal equivalent to the bearer_modify_request signal is delivered to the PCRF 1024 via several physical network constitutional elements. For example, the NAS signal transmitted by the terminal 1200 is delivered to the PCRF 1204 via an eNB 1202, an MME, an SGW, and a PGW 1206. Further, the terminal 1200 adds a flag indicating the start of the main object to a packet of a session which requests the main object, downloads the main object and thereafter add a flag indicating the end of the main object to a packet of a session which requests an embedded object, and then transmits the packets. In this case, the packet transmitted by the terminal 1200 is transmitted to a server 1208 via the eNB 1202 and the PGW 1206, and the PCRF 1204 recognizes the start and end of the main object by monitoring the packet arrived to the PGW 1206 through a Gx interface.

According to an exemplary embodiment of the present disclosure, the terminal 1200 detects the start and end of the main object by using a web packet generation time or by using a web browser. First, for a case of using the web packet generation time, if a web packet for a new TCP session is generated while the terminal 1200 does not generate a web packet during a pre-set time period, it is detected that the new TCP session is for a download of the main object, and the start of the main object is detected. For example, in general, when a user sees a web page through the web browser, a specific time is consumed from when loading of the web page is complete to when the user clicks the web page or inputs a URL to see another web page, and in this case, a characteristic in which a terminal does not transmit a packet to a network during the specific time duration is used to detect the start of the main object. Further, a characteristic can also be used in which a new TCP session is generated to download a plurality of embedded objects when the download of the main object is complete, and thus the end of main object is detected upon detection of a generation of new TCP session after detection of the start of the main object. Herein, a threshold time for a specific time in which a web packet is not generated is received from the PCRF 1204. That is, a timer for measuring the threshold time received from the PCRF 1204 starts (see 1222), and thereafter while a web packet is not transmitted/received until the timer expires (see 1224), the terminal 1200 detects that a session of the main object starts when a web packet of a new TCP session is first generated (see 1226). After detection of the session start of the main object, the terminal 1200 detects the end of the delivery of the main object when a new TCP session is generated again (see 1228). In this case, the web packet implies that a TCP destination port number is 80 or 8080. Further, the terminal 1200 determines whether it is a web packet for a new TCP session or a web packet for an old TCP session on the basis of information of a TCP session of the web packet (such as a source IP, a destination IP, a source port, a destination port).

Next, for a case of using the web browser, the terminal 1200 detects the start and end of the main object by using the web browser (see 1250), and reports the start and end of the main object by using a control signal or a NAS message. For example, the web browser included in the terminal 1200 downloads an HTML by using an internal software block called a main source loader when accessing a web by a user's selection operation or URL input. Thereafter, the web browser acquires information of an embedded object by interpreting the HTML, and downloads the embedded object by using an internal software block called a sub-resource loader. In doing so, the web browser 1250 determines whether an object to be downloaded is a main object or an embedded object. In the exemplary embodiment of the present disclosure, a modem of the terminal 1200 receives a report indicating the start of the main object session from the web browser (see 1252) to detect the start of the main object session, and receives a report indicating the end of the main object session from the web browser (see 1254) to detect the end of the main object session.

The PCRF 1204 receives a report indicating a delivery start of the main object in a specific TCP session from the terminal 1200 or monitors a packet delivered to the PGW 1206 through a Gx interface to detect the start of the main object. Upon detection of the start of the main object in the specific TCP session, the PCRF 1204 requests the PGW 1206 to adjust a transmission priority for a packet of the TCP session (see 1212) and thus increases the transmission priority for the packet of the TCP session. Further, the PCRF 1204 receives a report indicating a delivery end of the main object in the TCP session from the terminal 1200 or monitors the packet delivered to the PGW 1206 through the Gx interface to detect the end of the main object, thereby restoring or decreasing the transmission priority for the packet of the TCP session in the PGW 1004.

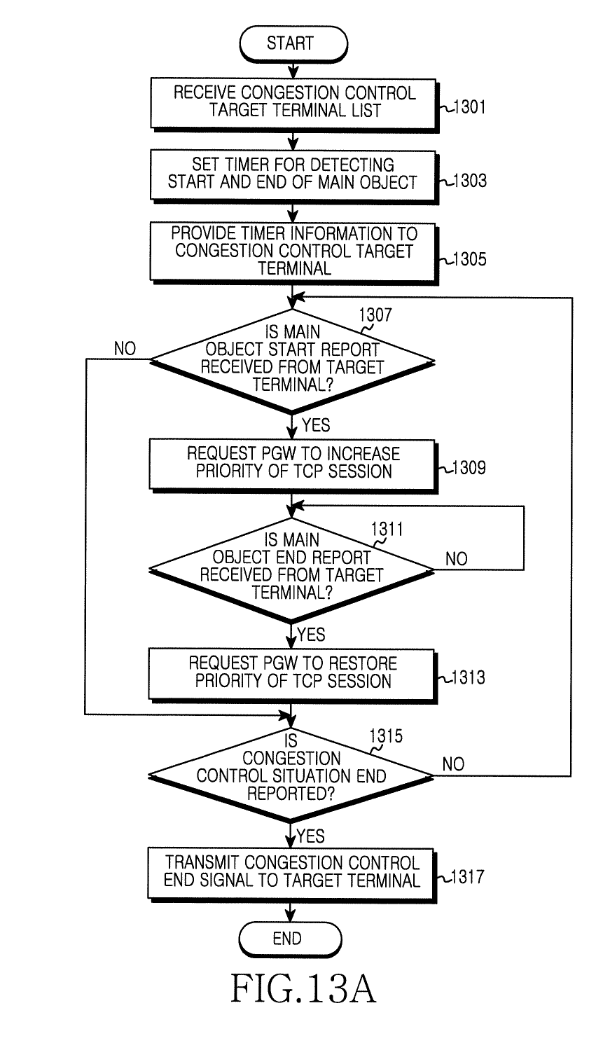

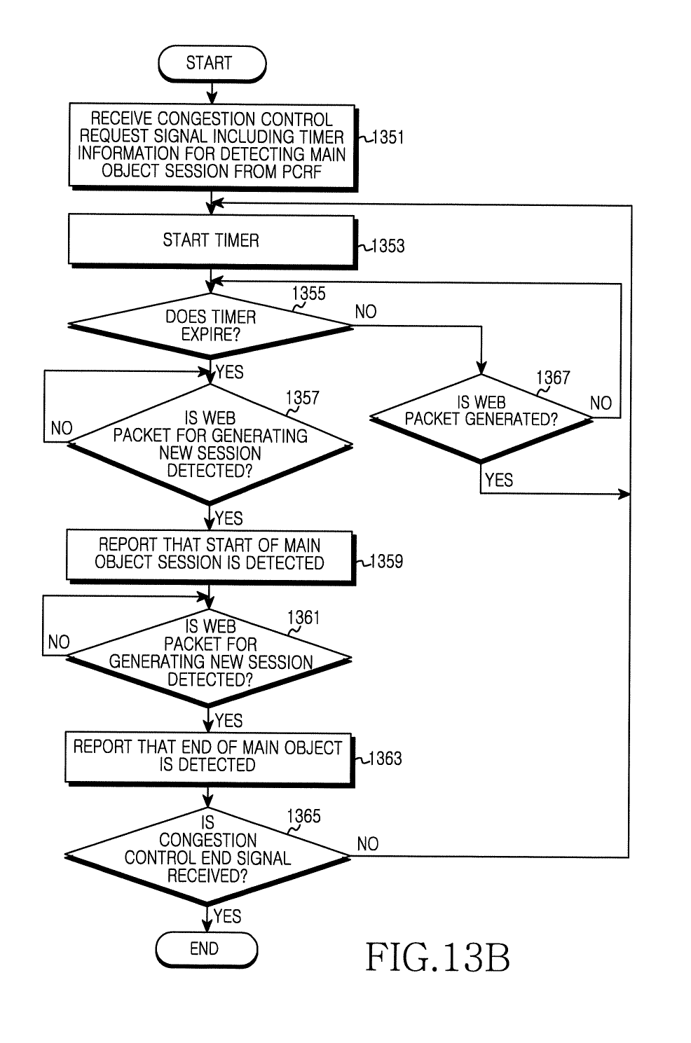

FIG. 13A illustrates an example method of a network controller for a case where a start and end of a main object are reported by using a web packet generation time in a terminal according to this disclosure. Herein, the network controller is the PCRF 1204. A case where the terminal reports the start and end of the main object by using a control signal is described herein for example. Referring to FIG. 13A, the network controller receives a congestion control target terminal list from a different network constitutional element (such as an MME) in step 1301. For example, the network controller receives a list of terminals currently accessing an eNB in which a congestion situation occurs.

In step 1303, the network controller sets a timer for detecting a start and end of a main object. In this case, the timer is set or changed through an experiment. In step 1305, the network controller provides information of the timer to congestion control target terminals included in the congestion control target terminal list. In step 1307, the network controller examines whether a signal for reporting the start of the main object is received from the congestion control target terminal. If the signal for reporting the start of the main object is not received, the network controller directly proceeds to step 1315. Otherwise, if the signal for reporting the start of the main object is received, in step 1309, the network controller requests the PGW to increase a priority of a TCP session corresponding to a terminal which reports the start of the main object. The network controller confirms information of the TCP session from the main object start reporting signal received from the terminal, and requests to increase the priority on the basis of the confirmed information of the TCP session.

In step 1311, the network controller examines whether a signal for reporting the end of the main object is received from the congestion control target terminal. If the signal for reporting the end of the main object is received, in step 1313, the network controller requests the PGW to restore the priority of the TCP session. The network controller confirms information of the TCP session from the main object end reporting signal received from the terminal, and requests to restore the priority on the basis of information of the confirmed TCP session. In step 1315, the network controller examines whether a signal for reporting an end of a congestion control situation is received from a different network constitutional element (such as an MME). For example, the network controller examines whether a signal for reporting an end of a congestion situation of a specific eNB is received from the MME.

If the end of the congestion control situation is not reported, returning to step 1307, the network controller repeats the subsequent steps. For example, the network controller examines whether a signal for reporting a start of a main object for a web traffic of a different terminal included in the congestion control target terminal list is received. Of course, the process for controlling the web traffic of each terminal included in the congestion control target terminal list is performed irrespective of a process for controlling the web traffic of the different terminal. Upon reception of the signal for reporting the end of the congestion control situation, in step 1317, the network controller transmits the congestion control end signal to the congestion control target terminals, and the procedure according to the exemplary embodiment of the present disclosure ends.

FIG. 13B illustrates an example method for reporting a start and end of a main object by using a web packet generation time in a terminal according to this disclosure. Referring to FIG. 3B, in step 1351, the terminal receives a congestion control request signal including timer information for detecting the main object session from the PCRF. For example, when a web packet is not generated for more than 1 second, the congestion control request signal indicates that the start of the main object session is detected.

In step 1353, the terminal starts a timer for measuring a time indicated by the timer information received from the PCRF. Thereafter, in step 1355, the terminal examines whether the timer expires. If the timer does not expire, the terminal examines whether the web packet is generated in step 1367. If the web packet is not generated in a situation where the timer does not expire, returning to step 1355, the terminal continuously examines whether the timer expires. On the other hand, if the web packet is generated in a situation where the timer does not expire, returning to step 1353, the terminal restarts the timer. That is, since a situation where the web packet is not generated is not continued for more than a specific time, the terminal determines that a condition of detecting the main object session is not satisfied, and restarts the timer.

If the timer expires, since the situation where the web packet is not generated is continued for more than the specific time, the terminal determines that the condition of detecting the main object session is satisfied, and examines whether a web packet for generating a new session is detected in step 1357. For example, upon detection of a packet of which a destination port address is 80 or 8080, the terminal determines the packet as a web packet, and determines whether it is a web packet for a new TCP session or a web packet for an old TCP session on the basis of information of a TCP session of the web packet (such as a source IP, a destination IP, a source port, a destination port).

Upon detection of a web packet for generating a new TCP session, the terminal reports to the PCRF that the start of the main object session is detected in step 1359. In step 1361, the terminal examines whether the web packet for generating the new session is detected. For example, if a web packet for generating a different new session is detected after the start of the main object session is detected, the terminal detects that a download of a main object is complete and a download of an embedded object starts. Upon detection of the web packet for generating the new session after the start of the main object session is detected, the terminal reports to the PCRF that the end of the main object session is detected in step 1363. Thereafter, in step 1365, the terminal examines whether a congestion control end signal is received. If the congestion control end signal is not received, returning to step 1353, the terminal repeats the subsequent steps, and if the congestion control end signal is received, the procedure according to the exemplary embodiment of the present disclosure ends.

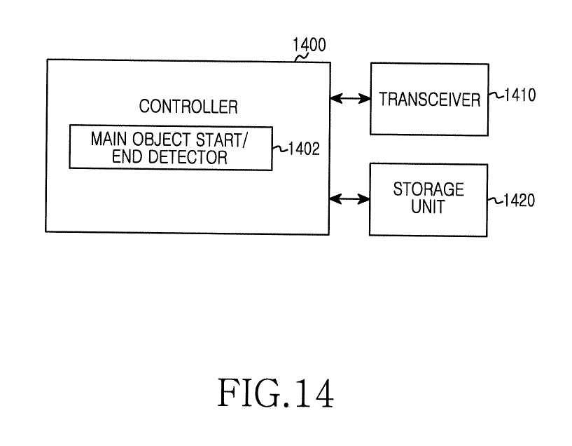

FIG. 14 is an example block diagram illustrating a structure of a network constitutional element for reporting a start and end of a main object according to this disclosure. Herein, the network constitutional element is any one of a terminal, a DPI device, and a server as shown in FIG. 8 to FIG. 13B described above. Referring to FIG. 14, the network constitutional element includes a controller 1400, a transceiver 1410, and a storage unit 1420. The controller 1400 detects a TCP session corresponding to a web content of a terminal which is in a network congestion situation under the control of the network controller, detects a transmission start and end of a main object of the web content by the use of a main object start/end detector 1402, and controls and processes a function for reporting the start and end of the main object to the network controller.

For example, if the network constitutional element is a server, as described above with reference to FIG. 9, the controller 1400 receives a congestion control target terminal list from the network controller, and when data of a specific web content is requested from a terminal included in the list, detects the start and end of the main object by using metadata of the requested data, and controls and processes a function for reporting the start and end of the main object to the network controller. In this case, the controller 1400 transmits a signal for reporting the start and end of the main object to the network controller, and transmits it by adding a flag for reporting the start and end of the main object to a packet of a content transmitted to the terminal.

For another example, if the network constitutional element is a DPI device, as described above with reference to FIG. 10 and FIG. 11B, the controller 1400 receives a congestion control target terminal list and a DPI rule including a start and end keyword of the main object from the network controller, detects a packet including the start and end keyword of the main object in a TCP session for a web content of a terminal included in the list to detect the start and end of the main object, and controls and processes a function for reporting the start and end of the main object to the network controller. In this case, the controller 1400 transmits a signal for reporting the start and end of the main object to the network controller.

For another example, if the network constitutional element is a terminal, as described above with reference to FIG. 12 and FIG. 13B, the controller 1400 detects the start and end of the main object by using a web packet generation time or by using a web browser. Upon detection of the start and end of the main object, the controller 1400 reports to the network controller that the start and end of the main object is detected by using a NAS equivalent to a control signal, and controls and processes a transmission function by indicating a main object start flag to a packet for requesting the main objet and by indicating a main object end flag to a packet for requesting an embedded object.

The transceiver 1410 performs a signal transmission/reception function between the network constitutional element and the network controller and a signal transmission/reception function between the network constitutional element and at least one different network constitutional element. For example, the transceiver 1410 transmits a signal for reporting the start of the main object and a signal for reporting the end of the main object to the network controller, and transmits a packet including a flag indicating the start of the main object and a packet including a flag indicating the end of the main object to the at least one different network constitutional element.

The storage unit 1420 stores a variety of data and programs required for an overall operation of the network constitutional element. For example, the storage unit 1420 stores a congestion control target terminal list received from the network controller. In addition, the storage unit 1420 stores a DPI rule including main object start and end keywords. In addition, the storage unit 1420 stores threshold time information regarding a web packet generation time (such as timer information). In addition, the storage unit 1420 stores a web content consisting of one main object and at least one embedded object. In this case, metadata of each object includes information indicating whether a corresponding object is a main object or an embedded object.

The present disclosure decreases a loading time of a web content by increasing a transmission priority of a main object constituting the web content in a network congestion situation. In this manner, a vendor satisfies more users of the web content by using the same resource. While the present disclosure has been particularly shown and described with reference to exemplary embodiments thereof, it will be understood by those skilled in the art that various modifications and changes in form and details is made therein without departing from the spirit of the disclosure.

Operations according to exemplary embodiments of the present disclosure is implemented by using a single controller. In this case, a program instruction for performing an operation implemented with various computers is recorded in a computer readable recording medium. The computer readable recording medium includes a program instruction, a data file, a data structure, or the like, in an independent or combined manner. The program instruction is designed and configured particularly for the present disclosure, or is known and usable to those ordinarily skilled in the art. The computer readable recording medium is a hardware device configured particularly to store and perform a program instruction, for example, a hard disk, a magnetic medium such as a floppy disc and a magnetic tape, an optical storage medium such as a Compact Disc-ROM (CD-ROM) or a Digital Versatile Disc (DVD), a magnetic-optic medium such as a floptical disc, a Read Only Memory (ROM), a Random Access Memory (RAM), a flash memory, or the like An example of the program instruction includes not only a machine language created by a compiler but also a high-level language executable by a computer by using an interpreter or the like. When a base station or a relay described in the present disclosure is entirely or partially implemented with a computer program, a computer readable recording medium which stores the computer program is also included in the present disclosure. Therefore, the scope of the disclosure is defined not by the detailed description of the disclosure but by the appended claims, and all differences within the scope will be construed as being included in the present disclosure.

What is claimed is:

1. A method of a network controller, the method comprising:
acquiring information of at least one terminal currently accessing a base station;
detecting a transmission control protocol (TCP) session to download a web content of a terminal; and
among a main object and at least one embedded object included in the web content, adjusting a priority for a transmission of the main object.

2. The method of claim 1, wherein the adjusting of the priority for the transmission of the main object comprises:
detecting whether a delivery of the main object starts;
upon detection of the delivery start of the main object, increasing a transmission priority of the main object;
detecting whether the delivery of the main object ends; and
upon detection of the delivery end of the main object, restoring the transmission priority of the main object to a priority before the increase,
wherein the transmission priority of the main object is adjusted by adjusting a priority of a bearer in which the main object is transmitted or by indicating a priority into a packet of the main object.

3. The method of claim 2, further comprising receiving a report indicating at least one of a delivery start of the main object and a delivery end of the main object from at least one network constitutional element, wherein the at least one network constitutional element comprises at least one of the terminal, a deep packet inspection (DPI) device, and a server to provide the web content.

4. The method of claim 2, wherein the delivery start of the main object and the delivery end of the main object are detected on the basis of a packet containing a flag indicating the delivery start of the main object and a packet containing a flag indicating the delivery end of the main object among packets of the web content transmitted from a server to provide the web content to the terminal.

5. A method of a network constitutional element, the method comprising:
among a main object and at least one embedded object included in a web content of a terminal, detecting a transmission start and end of the main object; and
reporting the transmission start and end of the main object to a network controller.

6. The method of claim 5, wherein if the network constitutional element is the terminal, detecting the transmission start and end of the main object comprises detecting the transmission start and end of the main object by using at least one of a web packet generation time and a web browser, and
wherein reporting the transmission start and end of the main object to the network controller comprises transmitting to the network controller a control signal to report the transmission start of the main object and a control signal to report the transmission end of the main object, or inserting a flag indicating the start of the main object into a packet to request a transmission of the main object and a flag indicating the end of the main object into a packet to request a transmission of an embedded object.

7. The method of claim 6, wherein detecting the transmission start and end of the main object comprises:
determining whether a time in which a web packet is not generated in the terminal is continued for more than a threshold time;
if the time in which the web packet is not generated in the terminal is continued for more than the threshold time, detecting whether a new TCP session for the web content is generated in the terminal;
if the new TCP session for the web content is generated in the terminal, determining that a transmission of the main object starts;
detecting whether a different new TCP session for the web content is generated after detecting the transmission start of the main object; and
if the different new TCP session for the web content is generated in the terminal, determining that the transmission of the main object ends.

8. The method of claim 5, wherein if the network constitutional element is a deep packet inspection (DPI) device, detecting the transmission start and end of the main object comprises:
detecting a packet containing any one of a main object start keyword and a main object end keyword by monitoring a packet provided to the terminal from a server to provide the web content;
upon detection of the packet containing the main object start keyword, detecting the transmission start of the main object; and
upon detection of the packet containing the main object end keyword, detecting the transmission end of the main object.

9. The method of claim 5, wherein if the network constitutional element is a server, detecting the transmission start and end of the main object comprises detecting the transmission start and end of the main object by using metadata, and
wherein reporting the transmission start and end of the main object to the network controller comprises transmitting to the network controller a control signal to report the transmission start of the main object and a control signal to report the transmission end of the main object, or inserting a flag indicating the start of the main object into a first transmission packet corresponding to the main object and a flag indicating the end of the main object into a last transmission packet corresponding to the main object.

10. The method of claim 5, further comprising, if the network constitutional element is any one of the DPI device and the server, receiving information regarding at least one terminal from the network controller, wherein a TCP session to download a web content of the terminal in which the information is received is detected.

11. An apparatus of a network controller, the apparatus comprising:
a transceiver configured to acquire information regarding at least one terminal currently accessing a base station; and
a controller configured to perform a function of detecting a Transmission Control Protocol (TCP) session to download a web content of a terminal, and among a main object and at least one embedded object included in the web content, adjusting a priority for a transmission of the main object.

12. The apparatus of claim 11, wherein the controller is configured to detect whether a delivery of the main object starts, and upon detection of the delivery start of the main object, the controller is configured to increase a transmission priority of the main object and detect whether the delivery of the main object ends, and upon detection of the delivery end of the main object, the controller is configured to restore the transmission priority of the main object to a priority before the increase, and
wherein the controller is configured to regulate the transmission priority of the main object by adjusting a priority of a bearer in which the main object is transmitted or by indicating a priority into a packet of the main object.

13. The apparatus of claim 12, wherein the transceiver is configured to receive a signal to report at least one of a delivery start of the main object and a delivery end of the main object from at least one network constitutional element, and
wherein the at least one network constitutional element contains at least one of the terminal, a deep packet inspection (DPI) device, and a server to provide the web content.

14. The apparatus of claim 12, wherein the controller is configured to detect the delivery start of the main object and the delivery end of the main object on the basis of a packet containing a flag indicating the delivery start of the main object and a packet containing a flag indicating the delivery end of the main object among packets of the web content transmitted from a server to provide the web content to the terminal.

15. An apparatus of a network constitutional element, the apparatus comprising:
a controller configured to, among a main object and at least one embedded object included in a web content of a terminal, detect a transmission start and end of the main object; and
a transceiver configured to report the transmission start and end of the main object to a network controller.

16. The apparatus of claim 15, wherein if the network constitutional element is the terminal, the controller is configured to detect the transmission start and end of the main object by using at least one of a web packet generation time and a web browser, and
wherein the controller is configured to perform a function for transmitting to the network controller a control signal to report the transmission start of the main object and a control signal to report the transmission end of the main object, or a function to insert a flag indicating the start of the main object into a packet to request a transmission of the main object and a flag indicating the end of the main object into a packet to request a transmission of an embedded object.

17. The apparatus of claim 16, wherein the controller is configured to determine that a transmission of the main object starts if a new TCP session for a web content is generated in the terminal in a state where a time in which the web packet is not generated in the terminal and is continued for more than a threshold time, and determine that the transmission of the main object ends if a different new TCP session for the web content is generated after detecting the transmission start of the main object.

18. The apparatus of claim 15, wherein if the network constitutional element is a deep packet inspection (DPI) device, the controller is configured to detect a packet containing any one of a main object start keyword and a main object end keyword by monitoring a packet provided to the terminal from a server to provide the web content, detect the transmission start of the main object upon detection of the packet containing the main object start keyword, and detect the transmission end of the main object upon detection of the packet containing the main object end keyword.

19. The apparatus of claim 15, wherein if the network constitutional element is a server, the controller is configured to detect the transmission start and end of the main object by using metadata, and
wherein the controller is configured to control a function to transmit to the network controller a control signal to report the transmission start of the main object and a control signal to report the transmission end of the main object, or a function to insert a flag indicating the start of the main object into a first transmission packet corresponding to the main object and a flag indicating the end of the main object into a last transmission packet corresponding to the main object.

20. The apparatus of claim 15, wherein if the network constitutional element is any one of the DPI device and the server, the transceiver is configured to receive information regarding at least one terminal from the network controller, and
wherein the controller is configured to perform a function to detect TCP session to download a web content of the terminal in which the information is received.
